(19) United States
(12) Patent Application Publication
(10) Pub. No.: US 2005/0169391 A1
(43) Pub. Date: Aug. 4, 2005

(54) Radio communications system using adaptive modulation, radio transmission apparatus and radio receiving apparatus

(76) Inventors: Daisuke Takeda, Tokyo (JP); Yuk Ching Chow, Bristol (GB)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/033,999

(22) Filed: Jan. 13, 2005

(30) Foreign Application Priority Data
Jan. 15, 2004 (GB) 0400875.1

(51) Int. Cl. H04L 27/00

(52) U.S. Cl. 375/259

(57) ABSTRACT

A radio communications system for performing communications based on an adaptive modulation by selecting one MCS from a set of MCSs each comprising a combination of a modulation scheme and a coding scheme which are ranked according to a transmission rate, the radio communications system comprising a change unit to change the selected MCS to a MCS of a higher ranking than the selected MCS when communication quality exceeds a first threshold, and change the selected MCS to a MCS of a lower ranking than the selected MCS when the communication quality is less than a second threshold lower than the first threshold, a first threshold controller to control the first threshold based on a first error rate, and a second threshold controller to control the second threshold based on a second error rate different from the first error rate.

### CROSS-REFERENCE TO RELATED APPLICATIONS

This application is based upon and claims the benefit of priority from United Kingdom Patent Application No. 0400875.1, filed Jan. 15, 2004, the entire contents of which are incorporated herein by reference.

### BACKGROUND OF THE INVENTION

1. Field of the Invention

The present invention relates to a radio communications system with the use of adaptive modulation.

2. Description of the Related Art

An adaptive modulation system is technology to be indispensable to improve a transmission rate, and used in IEEE 802.11a which is a standard of wireless LAN, or HSDPA (High Speed Downlink Packet Access). In the adaptive modulation system, a combination set of a modulation scheme and a coding scheme that differ in transmission rate or error tolerance, namely a MCS (Modulation and Coding Scheme) set is prepared. An optimum MCS is selected from a MCS set according to, for example, a propagation path situation.

A parameter to express communication quality, for example, SIR (Signal to Interference Ratio) is used as a reference to determine a MCS to be selected. In other words, the measured SIR is compared with a certain threshold, and the MCS is determined according to the comparison result. The optimum threshold for the comparison depends upon the propagation path situation and a kind of MCS. For this reason, it is difficult to decide fixedly the optimum threshold. A document, for example, Japanese Patent Laid-Open No. 2003-37554 discloses a technique to change dynamically the threshold used for decision of MCS according to an error rate.

For concreteness, the document decides a step size for controlling the threshold by a target error rate. Assuming that, for example, a target error rate is 0.1, i.e., a target throughput is 0.9, and error detection is carried out every block of a received signal. In this case, if a block error is generated, the threshold is increased by 0.9 dB. If a block error is not generated, the threshold is decreased by 0.1 dB. This corresponds to a threshold control for setting the target error rate at 0.1, because that a block error is 1 when ten blocks are received is similar to that the threshold does not change.

According to the above document, the threshold (the upper threshold) used when changing the MCS to the higher ranking MCS and the threshold (the lower threshold) used when changing the MCS to the lower ranking MCS are controlled according to a detection result of the block error. However, since the target error rate is the same with respect to the upper and lower threshold values, the upper and lower thresholds are controlled with the same step size.

As above described, in the document, a target error rate, i.e., control step size in control of each of the upper and lower threshold values used in changing the MCS is set at the same value. In such a threshold control method, throughput may fall by a change of MCS in compliance with a transmission rate of each MCS and a setting target error rate.

The document discloses a mode of changing one of the upper and lower threshold values or a mode of keeping a difference between the upper and lower threshold values at a constant value. However, these modes are the same as the above in using a common target error rate in control of the upper and lower threshold values. Therefore, there is the same problem as the above.

It is an object of the present invention to provide a radio communications system enabling an appropriate MCS control without a fall of throughput.

### BRIEF SUMMARY OF THE INVENTION

An aspect of the present invention provides A radio communications system for performing communications based on an adaptive modulation by selecting one MCS (modulation and coding scheme) from a set of MCSs (modulation and coding schemes) each comprising a combination of a modulation scheme and a coding scheme which are ranked according to a transmission rate, the radio communications system comprising: a change unit configured to change the selected MCS to a MCS of a higher ranking than the selected MCS when communication quality exceeds a first threshold, and change the selected MCS to a MCS of a lower ranking than the selected MCS when the communication quality is less than a second threshold lower than the first threshold; a first threshold controller to control the first threshold based on a first error rate; and a second threshold controller to control the second threshold based on a second error rate different from the first error rate.

### BRIEF DESCRIPTION OF THE SEVERAL VIEWS OF THE DRAWING

FIG. 1 is a block diagram of a base station according to the first embodiment of the present invention;

FIG. 2 is a block diagram of a terminal according to the first embodiment of the present invention;

FIG. 3 is a flow chart showing a control procedure of the upper threshold and the lower threshold according to the first embodiment of the present invention;

FIG. 4 is a diagram showing increase and decrease of the upper threshold and the lower threshold according to the first embodiment of the present invention;

FIG. 5 is a diagram showing increase and decrease of the upper threshold and lower threshold according to the first comparative example;

FIG. 6 is a diagram showing increase and decrease of the upper threshold and lower threshold according to the second comparative example;

FIG. 7 is a diagram showing a simulation result of throughput characteristic obtained in controlling the upper threshold and lower threshold according to the first embodiment of the present invention;

FIG. 8 is a flow chart showing a control procedure of the upper threshold and lower threshold according to the second embodiment of the present invention;

FIG. 9 is a block diagram of a terminal according to the third embodiment of the present invention;

FIG. 10 is a flow chart showing a control procedure of the upper threshold and lower threshold according to the third embodiment of the present invention;

FIG. 11 is a block diagram of a base station according to the fourth embodiment of the present invention; and

FIG. 12 is a block diagram of a terminal according to the fourth embodiment of the present invention.

### DETAILED DESCRIPTION OF THE INVENTION

### First Embodiment

The radio communications system according to the first embodiment of the present invention is applied to a wireless LAN or mobile communication system (cellular system) including at least one base station and at least one terminal. There is described an example which applies adaptive modulation to transmission of a message from the base station to the terminal, hereinafter.

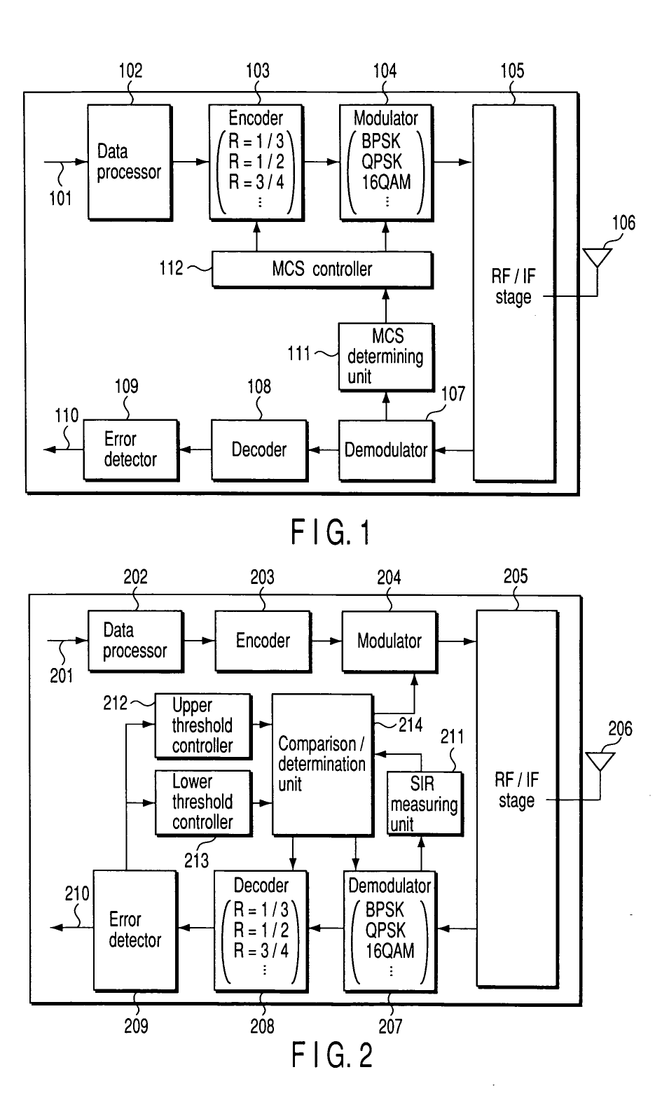

The base station on a transmitting side of a down link according to the first embodiment is described with reference to FIG. 1.

Transmission data 101 which should be transmitted by the down link is input by an upper layer. The transmission data 101 is subjected to processes such as addition of an error detection bit or segmentation in encoding unit, for example, in units of a block by means of a data processor 102. The output data from the data processor 102 is subjected to error correction coding by an encoder 103 and modulated by a modulator 104. The data subjected to the error correction coding and modulation is input to a RF/IF stage 105. The data input to the RF/IF stage 105 is at first converted into an IF (Intermediate Frequency) signal and then converted into an RF (Radio Frequency) signal, and thereafter subjected to a power amplification. The RF signal output from the RF/IF stage 105 is supplied to an antenna 106 to be transmitted to a terminal of FIG. 2 from the antenna 106.

On the other hand, the RF signal transmitted in an up link by the terminal of FIG. 2 and received by the antenna 106 is input to the RF/IF stage 105. The RF signal input to the RF/IF stage 105 is at first amplified with a low noise amplifier and converted into an IF signal and further converted into a baseband signal. The baseband signal output from the RF/IF stage 105 is demodulated with a demodulator 107. The demodulated signal is decoded with a decoder 108. The decoded data output from the decoder 108 is sent as receive data 110 to a next stage via an error detector 109.

An encoder 103 can correspond to a plurality of coding schemes different in coding rate to one another in the present embodiment, and encode in a selected coding scheme. Concretely, the encoder 103 can select a coding rate R from R=⅓, R=½, R=¾ and R=⅚. Error tolerance increases as the coding rate R decreases. For this reason, when the transmission channel is good, throughput increases as R increases.

A modulator 104 can correspond to a plurality of modulation schemes, and encode by a selected modulation scheme. In other words, the modulator 104 can select a modulation scheme from BPSK (Binary Phase Shift Keying), QPSK (Quadrature Phase Shift Keying), 16-level QAMs (Quadrature Amplitude Modulation) and 64-level QAMs. These modulation schemes differ in the number of modulation multiple values as being 2, 4, 16 and 64. The error tolerance increases as the number of the modulation multiple value decreases. The transmission rate increases as the number of the modulation multiple value increases. For this reason, if the transmission channel is good, the throughput increases as the number of the modulation multiple value increases, like the coding rate.

A combination of the modulation scheme (the number of modulation multiple value) and coding scheme (coding rate) is referred to as MCS (Modulation and Coding Scheme), and a plurality of combinations are called a MCS set. The MCS set is ranked by the transmission rate. If four modulation schemes BPSK, QPSK, 16-level QAM and 64-level QAM are assumed, the MCS including BPSK is the last rank. The MCS including QPSK is a higher rank than the MCS including BPSK. The MCS including 16-level QAM is a higher rank than the MCS including QPSK and the MCS including 64-level QAM is the highest rank. Even if the modulation schemes are the same, if the coding rate R differs, the rank of MCS differs. For example, even if the modulation scheme is the same 16-level QAM, R=⅚ is a higher rank than R=½.

In transmission of the down link, a MCS is selected from the MCS set as follows. At first, a MCS is determined by an MCS determination unit 111 according to a MCS change request extracted from the output of the demodulator 107. The MCS change request is information requesting a change of the MCS to be used with the base station at the time of the transmission of the down link. In the present embodiment, the MCS change request is transmitted to the base station from the terminal. The MCS determination unit 111 outputs MCS information indicating the determined MCS. The MCS is controlled by the MCS controller 112 according to this MCS information. In other words, one encoding scheme to be used in the encoder 103 and a modulation scheme to be used in the modulator 104 are selected. However, the coding rate of the encoding scheme may be selected by puncture or repetition of the output data from the encoder 103.

The terminal on the receive side of the down link is described with reference to next FIG. 2.

A data processor 202 subjects transmission data 201 to be transmitted from a higher layer via the up link to processes such as addition of an error detection bit or segmentation in an encoding unit. The output data from the data processor 202 is subjected to error correction encoding by an encoder 203 and then to modulation by a modulator 204. The data subjected to the error correction encoding and the modulation is input to a RF/IF stage 205. The data input to the RF/IF stage 205 is at first converted into an IF signal and then converted into a RF signal. Thereafter, the RF signal is subjected to power amplification and supplied to an antenna 206 to transmit the RF signal to the base station of FIG. 1.

In the down link, the RF signal transmitted by the base station of FIG. 1 antenna 206 is input to an RF/IF stage 205. The RF signal input to the RF/IF stage 205 is at first amplified by a low noise amplifier and then converted into an IF signal, and further converted into a baseband signal. The baseband signal output from the RF/IF stage 205 is demodulated by a demodulator 207. The demodulated signal is decoded by a decoder 208. The decoded data output from the decoder 208 is sent to the next stage via an error detector 209 as receive data 210. The error detector 209 detects an error of decoded data from the decoder 208 and output error detection information indicating whether an error occurs in.

The demodulator 207 can cope with a plurality of modulation schemes which the modulator 104 in the base station of FIG. 1 can deal with. In other words, the demodulator 207 demodulates the output of the RF/IF stage 205 according to a demodulation scheme corresponding to a selected modulation scheme. The decoder 208 can cope with a plurality of encoding schemes which the encoder 103 in the base station of FIG. 1 can deal with. In other words, the decoder 208 decodes the output of the demodulator 207 according to a decoding scheme corresponding to a selected encoding scheme.

In the terminal, SIR that is one of parameters representing communication quality is measured with respect to the output of the demodulator 207 with a SIR measuring unit 211 in accordance with a well-known technique at the time of reception of the down link. Information of the measured SIR is input to a comparison/determination unit 214. On the other hand, the error detection information from the error detector 209 is input to an upper threshold controller 212 and a lower threshold controller 213.

The comparison/determination unit 214-compares the upper and lower thresholds that are controlled by the upper and lower threshold controllers 212 and 213, respectively, with SIR and determine a change of MCS to output a MCS change request as a determination result. In other words, the comparison/determination unit 214 outputs the MCS change request for requesting to the base station to change the MCS to a higher ranking MCS than the current MCS if the measured SIR exceeds the upper threshold and to change the MCS to a lower ranking MCS than the current MCS if it is less than the lower threshold. When the measured SIR is between the upper threshold and the lower threshold, the comparison/determination unit 214 outputs a MCS no-change request. In this case, the current MCS is maintained in the base station.

The MCS change request and MCS no-change request output from the comparison/determination unit 214 are input to the modulator 204 and transmitted to the base station of FIG. 1 via the upper link. In the base station, the MCS decision unit 111 determines MCS according to the MCS change request included in the output of the demodulator 107 and supplies determined MCS information to the MCS controller 112.

The MCS change request output from the comparison/determination unit 214 is also input to the demodulator 207 and decoder 208. Therefore, the terminal selects the same MCS as that selected by the base station at the time of transmission of the down link. In other words, the demodulator 207 carries out demodulation corresponding to the modulation scheme selected by the modulator 104. The decoder 208 carries out decoding corresponding to the encoding scheme selected by the encoder 102.

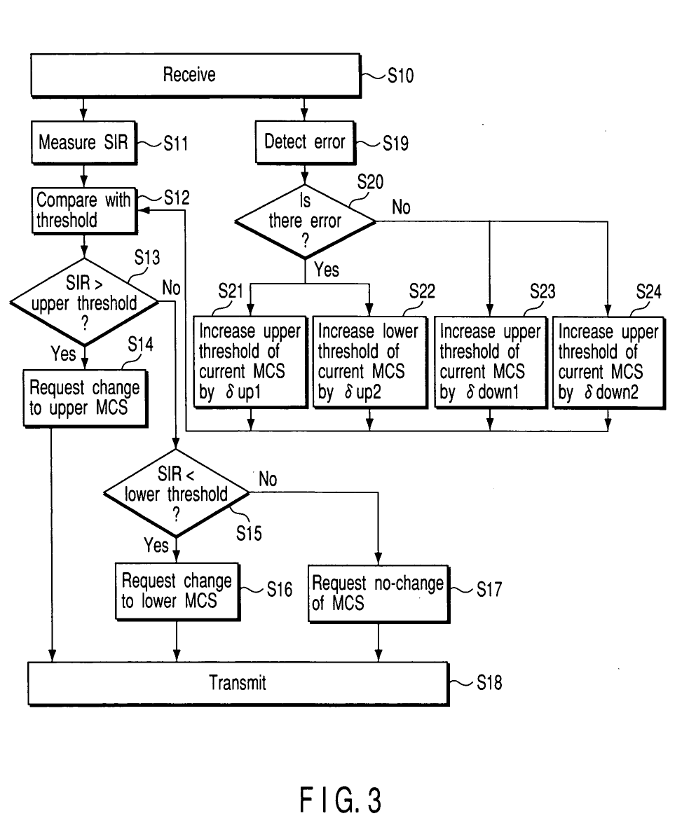

A control procedure of MCS in the down link according to the first embodiment is described in conjunction with FIG. 3 hereinafter.

At first, the terminal showed in FIG. 2 receives the RF signal transmitted by the base station showed in FIG. 1 via the antenna 106 (step S10), and measures SIR of the received RF signal in the SIR measuring unit 211 on the basis of the output signal of the demodulator 207 (step S11). The measured SIR is compared with the upper threshold and the lower threshold by the comparison/determination unit 214 (step S12). It is determined whether the SIR exceeds the upper threshold (step S13).

If the measured SIR exceeds the upper threshold, the comparison/determination unit 214 outputs a change request to a higher ranking MCS than the current MCS (step S14). If the measured SIR does not exceed the upper threshold, the comparison/determination unit 214 determines whether the SIR is less than the lower threshold (step S15). If the measured SIR is less than the lower threshold, the comparison/determination unit 214 outputs a change request to a lower ranking MCS than current MCS (step S16). In step S15, if the measured SIR is not less than the lower threshold, the comparison/determination unit 214 outputs a MCS no-change request (step S17). The MCS change request and MCS no-change request that output from the comparison/determination unit 214 are transmitted to the base station of FIG. 1 via the modulator 204, RF/IF stage 205 and antenna 206 (step S18).

A control procedure of the upper and lower thresholds used in step S12 is described hereinafter.

When the terminal receives a RF signal from the base station in step S10, an error is detected by the error detector 109 (step S19) and presence of an error is determined (step S20). If an error is detected, the upper threshold controller 212 and lower threshold controller 213 increase the upper and lower thresholds of the current MCS only by given steps δup1 and δup2, respectively (step S21 and S22). On the other hand, if no error is detected, the upper threshold controller 212 and lower threshold controller 213 decrease the upper and lower thresholds of the current MCS only by given steps δdown1 and δdown2, respectively (step S23 and S24).

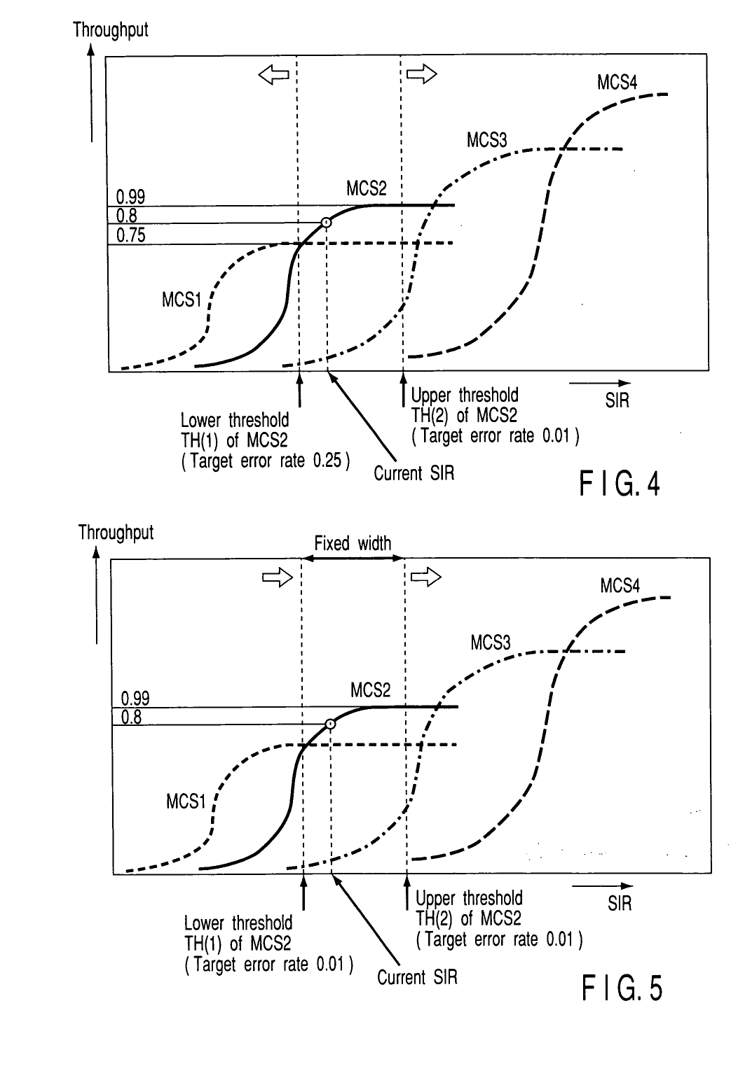

The controlling of the upper and lower thresholds by the upper and lower threshold controllers 212 and 213 will now be described in detail referring to FIG. 4.

Assuming that elements of the MCS set which can be used in current are MCS (n) (n=1, 2, . . . , N). MCS (n) expresses MCS to assume n as an index, for example, MCS (1)=MCS1, MCS (2)=MCS3, MCS (3)=MCS 8. n is an index number (=1, 2, n . . . , N), and N is the number of MCSs in an available MCS set. When MCS(k) (k=1, 2, . . . , N) is selected, if k<N, MCS of one higher rank than MCS(k) is expressed with MCS(k+1 ). If k>1, MCS of one lower rank than MCS(k) is expressed with MCS(k−1).

The upper threshold of MCS (k), namely the upper threshold when the MCS is changed from the current MCS (k) to a higher ranking MCS (k+1) assumes TH(k). The lower threshold of MCS(k), namely the lower threshold when the MCS is changed from the current MCS(k) to a lower ranking MCS(k−1) assumes TH(k−1). In that case of k=1, there is only TH(2) which is the upper threshold of MCS (1) and there is no lower threshold. In that case of k=N, there is only TH(N−1) which is the lower threshold of MCS(N) and there is no upper threshold. By the above-mentioned definition, TH(k) is used as the upper threshold or the lower threshold by the currently selected MCS. In other words, TH(k) is treated as the upper threshold when MCS (k) is selected and as the lower threshold when MCS (k+1) is selected.

The upper threshold controller 212 controls the upper threshold TH(k), for example, as follows. TH(k) is increased only by δup1=0.99 dB, when an error is detected. TH (k) is decreased only by δdown1=0.01 dB, when no error is detected.

The lower threshold controller 212 controls the lower threshold TH (k−1), for example, as follows. TH (k−1) is increased only by δup2=(Max_thpt{MCS(k−1)}/Max_thpt{MCS(k)})dB when an error is detected. TH (k−1) is decreased only by δdown2=(1.0−Max_thpt{MCS(k−1)}/Max_thpt{MCS(k)})dB when no error is detected. Max_thpt{x} expresses the maximum transmission rate of x. The maximum transmission rate means the maximum value of the transmission rate of the MCS in case that no error is existed.

In other words, the upper threshold TH(k) is controlled so that the throughput of MCS(k) becomes 0.99 of the maximum throughput (0.01 in error rate). More specifically, the upper threshold TH (k) is controlled assuming that the target throughput is 0.99 of the maximum throughput of MCS (k) (0.01 in target error rate). The lower threshold TH (k−1) is controlled so that the throughput becomes the maximum throughput of MCS (k−1). In other words, it is controlled assuming that the target throughput is the maximum throughput of MCS (k−1). The target throughput and target error rate represent target values of throughput and error rate in controlling the upper threshold or the lower threshold, respectively. There is now be concretely described a threshold control method when a MCS set is set as shown in Table 1.

TABLE 1

| | | Modulation | Maximum |
|---|---|---|---|
| | | scheme | Transmission |
| Index | MCS name | Coding rate | rate |
| MCS (1) | MCS1 | QPSK, R = ¾ | 9 Mbps |
| MCS (2) | MCS2 (current) | 16QAM, R = ½ | 12 Mbps |
| MCS (3) | MCS3 | 16QAM, R = ⅚ | 20 Mbps |
| MCS (4) | MCS4 | 64QAM, R = ¾ | 27 Mbps |

MCS1, MCS2, MCS3 and MCS4 are prepared for a MCS set as shown in table 1 and FIG. 4 (N=4). If the modulation scheme and coding rate are determined, the maximum transmission rate of each MCS is uniquely determined according to a frequency band used in the communication system. It is assumed that selected MCS, namely current MCS is MCS2 (k=2). The target error rate in controlling the upper threshold TH(2) (used when MCS is changed to MCS3 from MCS2) is assumed to be 0.01 (target throughput is 0.99). The target error rate in controlling the lower threshold TH(1) of MCS2 (used when MCS is changed to MCS1 from MCS2) is 1− 9/12=0.25 (0.75 in throughput) using the maximum transmission rate of MCS1 as a reference.

In the case of the above example, the upper threshold controller 212 controls the upper threshold TH(2) as follows. In other words, when an error occurs for a single block, TH(2) is increased by δup1=0.99 dB. When no error occurs for the block, TH(2) is decreased by δdown1=0.01 dB. The lower threshold controller 212 controls the lower threshold TH(1) as follows. In other words, when a single block error occurs, TH(1) is increased by δup2=(Max_thpt{MCS(1)}/Max_thpt{MCS(2)})dB, namely 9/12 dB (0.75 dB). When no block error occurs, TH(1) is decreased by δdown2=(1.0−Max_thpt{MCS(1)}/Max_thpt{MCS(2)})dB, namely 1− 9/12=0.25 dB.

When the measured SIR exceeds the upper threshold TH(2) of MCS 2 in the case that the current MCS is MCS2, MCS is changed from MCS2 to MCS3.

When MCS3 is selected, the target error rate in controlling the upper threshold TH(3) (threshold used when MCS is changed to MCS4 from MCS3) is set at 0.01 (target throughput is 0.99). The target error rate in controlling the lower threshold TH(2) of MCS3 (threshold used in changing MCS to MCS2 from MCS3) is set at 1− 12/20=0.40 (target throughput is 0.60) using the maximum transmission rate of MCS1 as a reference.

In the case of the above example, the upper threshold controller 212 controls the upper threshold TH(3) as follows. In other words, when an error occurs for a single block, TH(3) is increased by δup1=0.99 dB. When no error occurs for the block, TH(3) is decreased by δdown1=0.01 dB. The lower threshold controller 212 controls the lower threshold TH(2) as follows. In other words, when an error occurs for a single block, TH(2) is increased by δup2=(Max_thpt{MCS(2)}/Max_thpt{MCS(3)})dB, namely 12/20 dB (0.60 dB). When no error occurs for the block, TH(1) is decreased by δdown2=(1.0−Max_thpt{MCS(2)}/Max_thpt{MCS(3)})dB, namely 1− 12/20=0.40 dB.

In the prior art document, the upper threshold and lower threshold is controlled according to the same step size, namely the same target value. The concrete example of control of the upper threshold and lower threshold according to the prior art document is described as examples 1 and 2 for the purpose of comparing with the present embodiment.

### COMPARATIVE EXAMPLE 1

The target error rates corresponding to the upper threshold and lower threshold of the current MCS2 are together set at 0.01. In this case, the upper threshold and lower limit threshold are controlled as follows. In other words, if no block error occurs, the upper threshold and lower limit threshold are concurrently decreased by 0.01 dB. If a block error occurs, the upper threshold and lower threshold are together increased by 0.99 dB. Assuming that an actual error rate in the current SIR is 0.2 (i.e., 0.8 of the maximum transmission rate of MCS 2 in throughput) as shown in FIG. 5. In this case, if 100 blocks are received, 80 blocks have no error but 20 blocks include errors. A threshold control is done whenever each block is received. As a result, the increased width of the threshold after reception of 100 blocks is 20*0.99=1.98 [dB] or the decreased width of the threshold is 80*0.01=0.8 [dB]. Thus, the upper threshold and lower threshold are together increased by 1.98−0.8=1.18 [dB]. The width between the upper threshold and lower threshold is fixed. Both of the upper threshold and lower limit threshold increase according to passage of time. When the current SIR comes across the lower threshold before long, MCS is changed to MCS1 of a lower ranking than the MCS. In this example, throughput falls.

### COMPARATIVE EXAMPLE 2

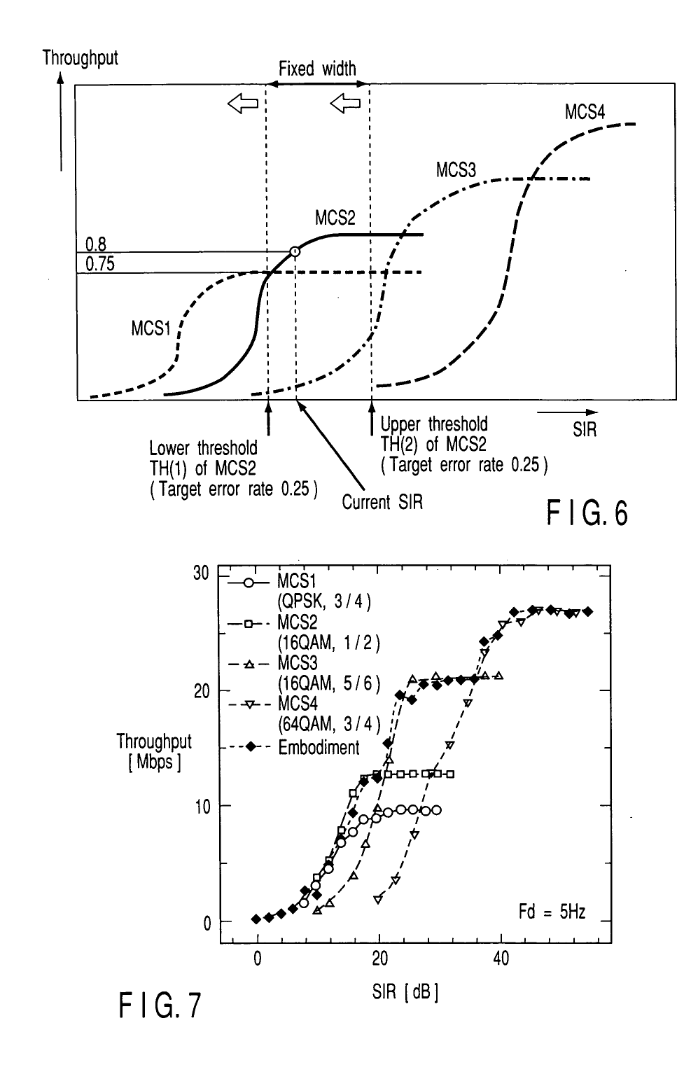

On the other hand, a target error rate with respect to MCS2 is set at 0.25 higher than that of the comparative example 1. In this case, the upper threshold and lower threshold are controlled as follows. If no block error occurs, the upper threshold and lower threshold are together decreased by 0.75 dB. If a block error occurs, the upper threshold and lower threshold are together increased by 0.25 dB. Assuming that an actual error rate in the current SIR is 0.2 (i.e., 0.8 of the maximum transmission rate of MCS 2 in throughput) as shown in FIG. 6 like FIG. 5. In this case, if 100 blocks are received, 80 blocks have no error but 20 blocks include errors. A threshold control is done whenever each block is received. As a result, the increased width of the threshold after reception of 100 blocks is 20*0.75=1.50 [dB]. The decreased width of the threshold is 80*0.25=2.0 [dB]. Thus, the upper threshold and lower threshold are together decreased by 2.0−1.5=0.5 [dB]. The width between the upper threshold and lower threshold is fixed. Both of the upper threshold and lower limit threshold decrease according to passage of time. When the current SIR comes across the upper threshold before long, MCS is changed to MCS1 of a higher ranking than the MCS. Even this case, throughput falls.

In contrast, according to the first embodiment, the upper threshold and lower threshold are controlled according to different target error rates or different target throughputs, respectively, as described above. When the current MCS is MCS2 as shown in FIG. 4, for example, the above threshold control is done. In other words, the target error rate of the upper threshold of MCS2 is at 0.01, and the target error rate of the lower threshold of MCS2 is set at 0.25. Assuming that an actual error rate is 0.2 similarly to the comparative examples 1 and 2. When 100 blocks are received, the upper threshold is increased by 1.18 dB due to computation similar to the comparative example 1. The lower threshold is increased by 0.5 dB due to computation similar to the comparative example 2. Therefore, when time passes, the upper threshold increases and the lower threshold decreases. This continues selecting MCS2 that is an optimum MCS. In other words, the present invention can realize selection of the optimum MCS without decreasing throughput.

The advantage attained by the control of the upper threshold and lower threshold according to the first embodiment are evident from FIG. 7 showing a simulation result of throughput characteristic. In FIG. 7, an abscissa axis is SIR and an axis of ordinates is throughput in applying a HiperLAN/2 multipath model to a MCS set of the table 1. It can be understood from FIG. 7 that such optimum MCS as to increase the throughput with respect to a change of SIR is selected.

### Second Embodiment

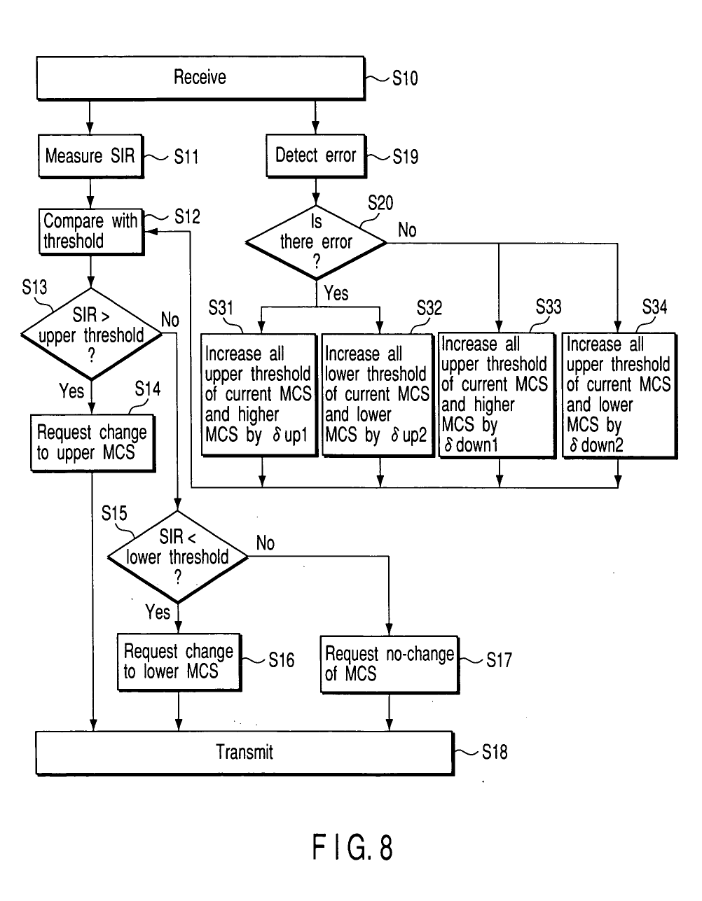

The second embodiment of the present invention will be described hereinafter. A base station and a terminal according to the second embodiment are similar to the first embodiment in configuration. In the second embodiment, MCS control in the down link is carried out according to a procedure shown in FIG. 8. In the procedure of FIG. 3 according to the first embodiment, only the upper threshold and lower threshold of the current MCS are controlled in controlling the upper threshold and lower threshold used in step S12. In contrast, in the second embodiment, the upper and lower thresholds of all MCSs including the current MCS are controlled.

In other words, an error is detected by an error detector 209 in steps S19 and S20 after a RF signal is received from a base station in step S1. When the error is detected, the upper threshold controller 212 and lower threshold controller 213 increase the upper and lower thresholds of the current MCS and all MCSs of higher rank than the current MCS by a constant step (step S31 and S32). If no error is detected, the upper threshold controller 212 and lower threshold controller 213 decrease the upper and lower thresholds of the current MCS and all MCSs of higher rank than the current MCS by a constant step (step S33 and S34).

There will now be described the content of the control of the upper threshold and lower threshold that is carried out by the upper threshold controller 212 and lower threshold controller 213.

Similarly to the first embodiment, in a MCS set defined in MCS(n) (n=1, 2, . . . , N) where n is an index, the current MCS is set at MCS(k) (k=1, 2, 3, . . . , N), the MCS of the higher rank than MCS (k) is set at MCS (k+1) (k<N), and the MCS of the lower rank than MCS(k) is set at MCS (k−1) (k>1). For example, MCS (1)=MCS1, MCS(2)=MCS 3, and MCS(3)=MCS 8. N is the number of MCSs in an available MCS set.

The upper thresholds of MCS(k) corresponding to the current MCS and all MCSs of the higher rank than the MCS(k) are set at TH (k), TH(k+1), . . . , TH (N−1) (k<N), respectively. The lower thresholds of MCS (k) corresponding to the current MCS and all MCSs of the lower rank than the MCS(k) are set at TH(k−1), TH(k−2), . . . , TH(1) (k>1), respectively. However, when k=1, there is only the upper threshold TH(2) with respect to MCS(1), and when k=N, there is only the lower threshold TH(N−1) with respect to MCS (N). This is similar to the first embodiment.

The upper threshold controller 212 controls the upper thresholds TH(k), TH(k+1), . . . , TH(N−1), for example, as follows. When no error is detected, TH(k), TH(k+1), . . . , TH(N−1) are decreased by εdown1=0.01 dB. When an error is detected, TH(k), TH(k+1), . . . , TH(N−1) are increased by δup1=0.99 dB.

On the other hand, the lower threshold controller 212 controls the lower threshold TH(k−1), TH(k−2), . . . , TH(1), for example, as follows. When no error is detected, TH (k−1), TH (k−2), . . . , TH (1) are decreased by δdown2=(1.0−Max_thpt{MCS(k−1)}/Max_thpt{MCS(k)})dB. When an error is detected, TH (k−1), TH (k−2), . . . , TH (1) are increased by δup2=(Max_thpt{MCS(k−1)}/Max_thpt{MCS(k)})dB. Max_thpt{x} expresses the masimum throughput of x.

In other words, the upper threshold TH(k), TH(k+1), . . . , TH(N−1) are controlled so that the throughput becomes 0.99 of the maximum transmission rate of MCS(k) (an error rate is 0.01), that is, the target throughput is 0.99 of the maximum transmission rate of MCS (k) (a target error rate is 0.01). The lower threshold TH(k−1), TH(k−2), . . . , TH(1) are controlled so that the throughput becomes the maximum transmission rate of MCS (k−1), that is, the target throughput is the maximum transmission rate of MCS(k−1). As thus described, according to the second embodiment, the upper threshold and lower threshold are controlled according to different target error rates or different target throughputs, respectively. Therefore, the second embodiment can realize selection of the optimum MCS similarly to the first embodiment.

Further, the second embodiment can avoid that the upper threshold of the current MCS or the lower threshold thereof exceeds the thresholds of other MCSs by increasing and decreasing in parallel the threshold of the current MCS and the thresholds of other MCSs.

### Third Embodiment

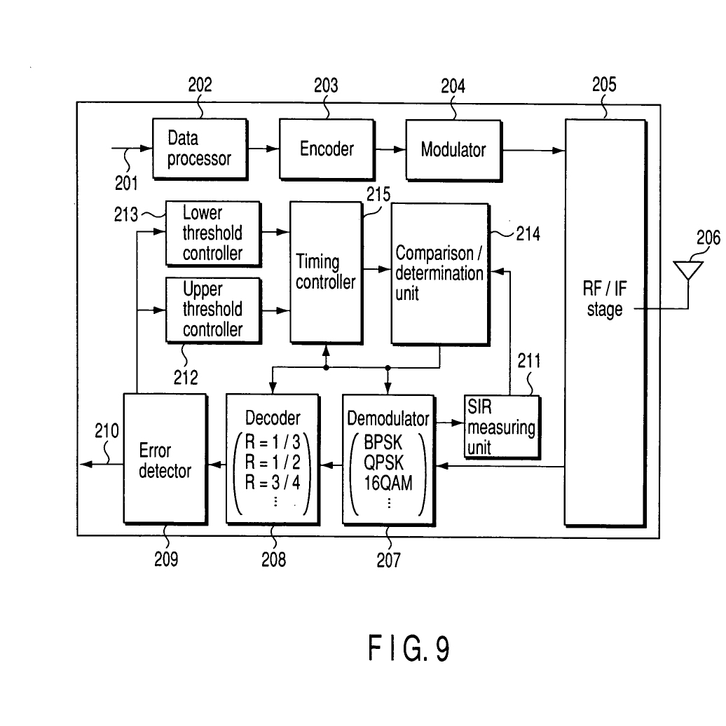

According to the third embodiment of the present invention, a timing controller 215 is added to the terminal of the first embodiment as shown in FIG. 9. The timing controller 215 carries out a control to transmit a MCS change request based on a comparison result between the SIR and the upper threshold and lower threshold in the comparison/determination unit 214 and thereafter to prohibit transmission of a next MCS change request for a fixed period of time.

As explained in the first embodiment, in the terminal, the same MCS as that of the RF signal transmitted by the base station and received by the terminal is selected. The RF signal is demodulated and decoded by the demodulator 207 and the decoder 208 according to corresponding modulation scheme and encoding scheme. An error is detected from the output signal of the decoder 208 by the error detector 209. Error detection information indicating error detection is sent from the error detector 209 to the upper threshold controller 212 and lower threshold controller 213. The upper threshold and lower threshold controlled by the upper threshold controller 212 and lower threshold controller 213 are input to the comparison/determination unit 214 via the timing controller 215 and compared with the SIR value measured with the SIR measurement unit 211.

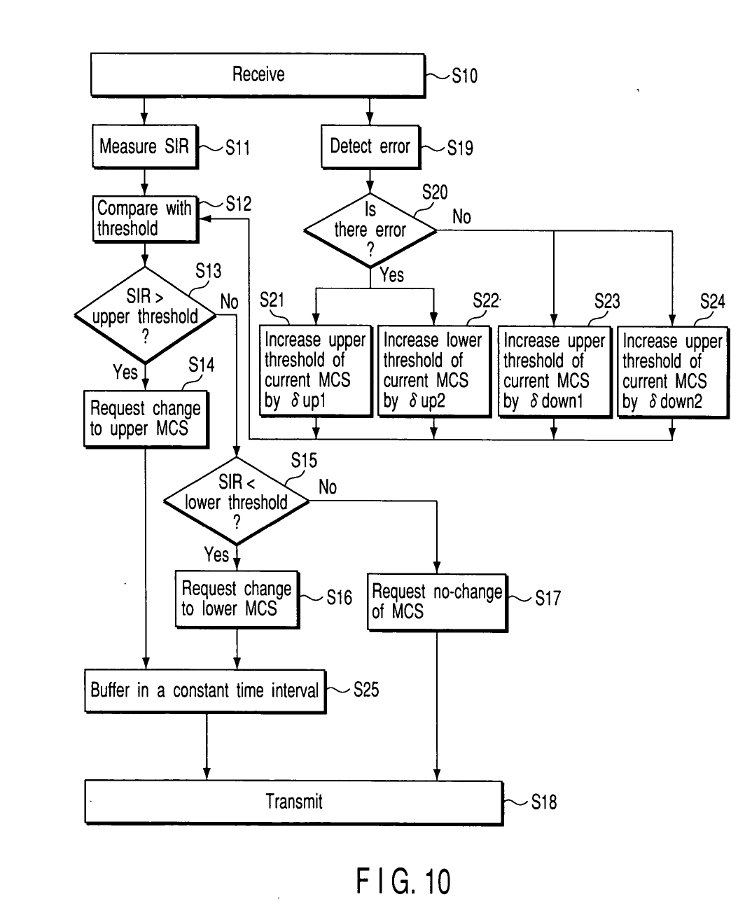

In the third embodiment, threshold control is done for a fixed period of time just after the MCS is changed according to a MCS change request from the comparison/determination unit 214. However, the MCS change request is not sent by control of the timing controller 215. As shown in FIG. 10 to show a flow of a process in the present embodiment, even if a MCS change request occurs in step S14 or step S16, it is buffered for a fixed period of time by control of the timing controller 215 (step S25). When the fixed period of time elapses, the MCS change request generated in step S14 or step S16 is transmitted to the base station (step S18).

In the threshold control algorithm explained in the first embodiment, only the upper threshold and lower threshold of the current MCS are controlled. As a result, the controlled upper threshold and lower threshold may exceed the thresholds of other MCSs. Assuming that, for example, the upper threshold of MCS1 (the upper threshold used in changing MCS to MCS2 from MCS1) is set at 10 dB, and the upper threshold of MCS2 (the upper threshold used in changing MCS from MCS2 to MCS3) is at 15 dB.

In this case, when the current MCS is MCS 1, the upper threshold must be controlled to be 10 dB but may be controlled to exceed the upper threshold 15 dB of MCS2. As a result, when the state of a transmission channel is restored and SIR increases, the upper threshold exceed already the upper threshold 15 dB of MCS2 in changing MCS from MCS1 to higher ranking MCS2. However, because it is uncertain that the upper threshold 10 dB of MCS2 is optimum, a comparatively long time is necessary till the upper threshold of MCS2 converges on the optimum value. According to the third embodiment, the change of MCS is prohibited for a fixed period of time just after a change of MCS, that is, for a period of time during which the measured SIR is between the upper threshold and lower threshold of the current MCS. As a result, performance degradation due to an unnecessary MCS change is prevented and more optimum MCS can be selected.

### Fourth Embodiment

In the above explanation, the comparison/determination unit 214 in the terminal transmits a MCS change request for changing MCS to a higher rank or a lower tanking MCS than the current MCS to the base station. In contrast, according to the fourth embodiment of the present invention, the comparison/determination unit 214 in the terminal is replaced with a MCS determination unit 216 as shown in FIG. 12.

The MCS determination unit 216 determines MCS to be changed by comparing SIR measured by the SIR measurement unit 211 with the upper threshold and bottom threshold controlled by the upper threshold controller 212 and lower threshold controller 213. In other words, since the terminal certainly recognizes the current MCS, the MCS determination unit 216 recognizes a higher ranking MCS or a lower ranking MCS than the current MCS. Therefore, the MCS determination unit 216 can determine MCS to be changed, by comparing SIR with the upper threshold and lower threshold.

The MCS determination unit 216 outputs MCS information indicating MCS to be changed determined in this way as a MCS change request. When the change of MCS is not required, the MCS determination unit 216 outputs MCS information indicating the current MCS. An index indicating MCS to be changed can be used for MCS information. The MCS information is input to the modulator 204, and transmitted from the antenna 106 to the base station via the RF/IF stage 105.

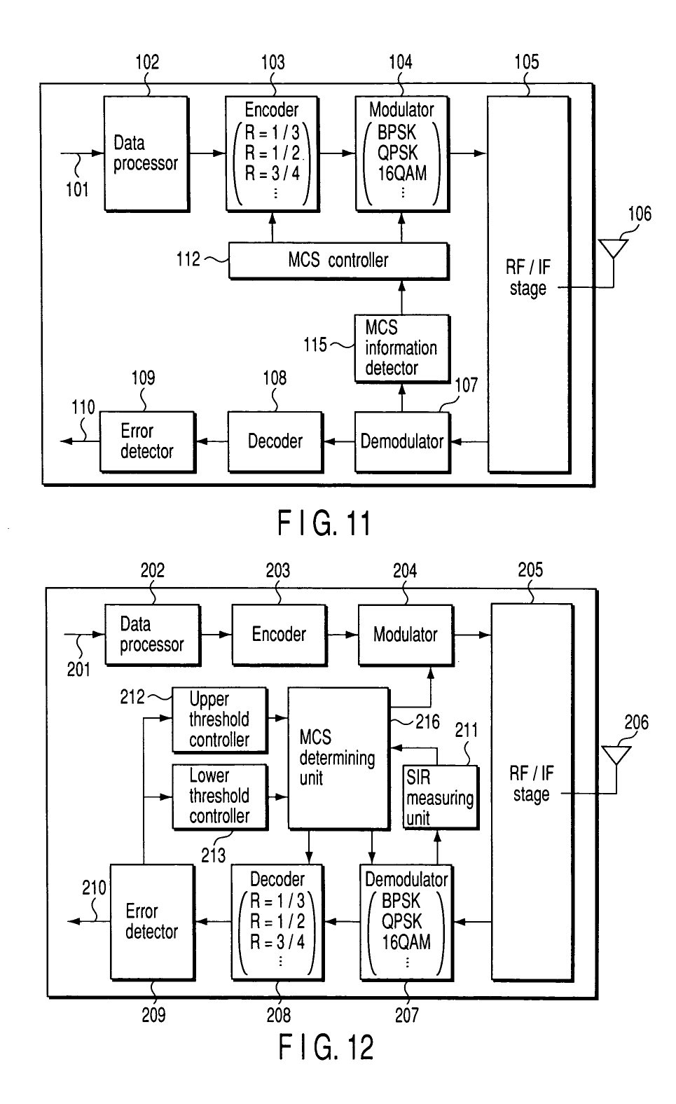

On the other hand, in the base station, the MCS information is detected from the output of the demodulator 107 by the MCS information detector 115 as shown in FIG. 11. The MCS information is input to the MCS controller 112. The MCS controller 112 carries out control of MCS according to the MCS information, that is, selects a modulation scheme to be used in the encoder 102 and an encoding scheme to be used in the modulator 103 according to the MCS information. The fourth embodiment provides a result similar to the first embodiment. Combination of the fourth embodiment and the third embodiment can be realized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A radio communications system for performing communications based on an adaptive modulation by selecting one MCS (modulation and coding scheme) from a set of MCSs (modulation and coding schemes) each comprising a combination of a modulation scheme and a coding scheme which are ranked according to a transmission rate, the radio communications system comprising:
a change unit configured to change the selected MCS to a MCS of a higher ranking than the selected MCS when communication quality exceeds a first threshold, and change the selected MCS to a MCS of a lower ranking than the selected MCS when the communication quality is less than a second threshold lower than the first threshold;
a first threshold controller to control the first threshold based on a first error rate; and
a second threshold controller to control the second threshold based on a second error rate different from the first error rate.

2. The radio communications system as claimed in claim 1, wherein the first threshold controller and the second threshold controller control only the first threshold and the second threshold, respectively, which are used for changing the selected MCS.

3. The radio communication system as claimed in claim 1, wherein the first threshold controller controls simultaneously first thresholds used for changing the selected MCS and all MCSs of a higher ranking than the selected MCS, and the second threshold controller controls simultaneously second thresholds used for changing the selected MCS and all MCSs of a lower ranking than the selected MCS.

4. The radio communications system as claimed in claim 1, further comprising timing controller to carry out a timing control for prohibiting to change the MCS by means of the change unit for a given period of time just after changing of the selected MCS.

5. The radio communications system as claimed in claim 1, wherein the second error rate is determined based on a maximum transmission rate of a MCS lower than the selected MCS by one rank, and the first error rate is determined to a value lower than the second error rate.

6. A radio communications apparatus used in a radio communications system for carrying out communications based on an adaptive modulation by selecting one MCS (modulation and coding scheme) from a set of MCSs (modulation and coding schemes) each comprising a combination of a modulation scheme and a coding scheme which are ranked according to a transmission rate, the radio communications apparatus comprising:
a measurement unit configured to measure communication quality;
a comparison unit configured to compare the measured communication quality with the first threshold and the second threshold and changing the selected MCS to a MCS of a higher ranking than the selected MCS when the measured communication quality exceeds the first threshold, the comparison unit generating a MCS change request for changing the selected MCS to a MCS of a lower ranking than the selected MCS, when the measured communication quality is less than a second threshold lower than the first threshold;
first threshold controller to control the first threshold based on a first error rate;
second threshold controller to control the second threshold based on a second error rate different from the first error rate; and
a transmission unit configured to transmit the change request.

7. The radio communications apparatus as claimed in claim 6, wherein the first threshold controller and the second threshold controller control only the first threshold and the second threshold, respectively, which are used for changing the selected MCS.

8. The radio communication system as claimed in claim 6, wherein the first threshold controller controls simultaneously first thresholds used for changing the selected MCS and all MCSs of a higher ranking than the selected MCS, and the second threshold controller controls simultaneously second thresholds used for changing the selected MCS and all MCSs of a lower ranking than the selected MCS,

9. The radio communications system as claimed in claim 6, wherein the second error rate is determined based on a maximum transmission rate of a MCS lower than the selected MCS by one rank, and the first error rate is determined to a value lower than the second error rate.

10. A radio communication apparatus comprising:
a receiver to receive the MCS change request transmitted by the radio communication apparatus as claimed in claim 6;
an MCS determination unit configured to determine a MCS to be changed according to the received MCS change request; and
an MCS change unit configured to change the selected MCS to the determined MCS.

11. A radio communications apparatus used in a radio communications system for carrying out communications based on an adaptive modulation by selecting one MCS (modulation and coding scheme) from a set of MCSs (modulation and coding schemes) each comprising a combination of a modulation scheme and a coding scheme which are ranked according to a transmission rate, the radio communications apparatus comprising:
a measuring unit configured to measure communication quality;
a determination unit configured to determine a MCS of a higher ranking than the selected MCS when the measured communication quality exceeds a first threshold, and to determine a MCS of a lower ranking than the selected MCS when the communication quality is less than a second threshold lower than the first threshold;
a first threshold controller to control the first threshold based on a first error rate; and
second threshold controller to control the second threshold based on a second error rate different from the first error rate.

12. The radio communications system as claimed in claim 11, wherein the first threshold controller and the second threshold controller control only the first threshold and the second threshold, respectively, which are used for changing the selected MCS.

13. The radio communication system as claimed in claim 11, wherein the first threshold controller controls simultaneously first thresholds used for changing the selected MCS and all MCSs of a higher ranking than the selected MCS, and the second threshold controller controls simultaneously second thresholds used for changing the selected MCS and all MCSs of a lower ranking than the selected MCS.

14. The radio communications system as claimed in claim 11, wherein the second error rate is determined based on a maximum transmission rate of a MCS lower than the selected MCS by one rank, and the first error rate is determined to a value lower than the second error rate.

15. The radio communication apparatus comprises:
a receiver to receive information transmitted by the radio communication apparatus as claimed in claim 11 and indicating the MCS to be changed, and
an MCS change unit configured to change the selected MCS to the determined MCS according to the received information indicating the MCS to be changed.

16. A radio communications system for performing communications based on an adaptive modulation by selecting one MCS (modulation and coding scheme) from a set of MCSs (modulation and coding schemes) each comprising a combination of a modulation scheme and a coding scheme which are ranked according to a transmission rate, the radio communications system comprising;
change means for changing the selected MCS to a MCS of a higher ranking than the selected MCS when communication quality exceeds a first threshold, and changing the selected MCS to a MCS of a lower ranking than the selected MCS when the communication quality is less than a second threshold lower than the first threshold;
first threshold control means for controlling the first threshold based on a first error rate; and
second threshold control means for controlling the second threshold based on a second error rate different from the first error rate.

17. A radio communications apparatus used in a radio communications system for carrying out communications based on an adaptive modulation by selecting one MCS (modulation and coding scheme) from a set of MCSs (modulation and coding schemes) each comprising a combination of a modulation scheme and a coding scheme which are ranked according to a transmission rate, the radio communications apparatus comprising;
measurement means for measuring communication quality;
comparison means for comparing the measured communication quality with the first threshold and the second threshold and changing the selected MCS to a MCS of a higher ranking than the selected MCS when the measured communication quality exceeds the first threshold, the comparison means generating a MCS change request for changing the selected MCS to a MCS of a lower ranking than the selected MCS, when the measured communication quality is less than a second threshold lower than the first threshold;
first threshold control means for controlling the first threshold based on a first error rate;
second threshold control means for controlling the second threshold based on a second error rate different from the first error rate; and
transmission means for transmitting the change request.

18. A radio communication apparatus comprising:
receiver means for receiving the MCS change request transmitted by the radio communication apparatus as claimed in claim 6;
MCS determination means for determining a MCS to be changed according to the received MCS change request; and
MCS change means for changing the selected MCS to the determined MCS.

19. A radio communications apparatus used in a radio communications system for carrying out communications based on an adaptive modulation by selecting one MCS (modulation and coding scheme) from a set of MCSs (modulation and coding schemes) each comprising a combination of a modulation scheme and a coding scheme which are ranked according to a transmission rate, the radio communications apparatus comprising;
measuring means for measuring communication quality;
determination means for determining a MCS of a higher ranking than the selected MCS when the measured communication quality exceeds a first threshold, and for determining a MCS of a lower ranking than the selected MCS when the communication quality is less than a second threshold lower than the first threshold;
first threshold control means for controlling the first threshold based on a first error rate; and
second threshold control means for controlling the second threshold based on a second error rate different from the first error rate.

20. A communications method for a radio communications system of performing communications based on an adaptive modulation by selecting one MCS (modulation and coding scheme) from a set of MCSs (modulation and coding schemes) each comprising a combination of a modulation scheme and a coding scheme which are ranked according to a transmission rate, the communications method comprising the steps of:
changing the selected MCS to a MCS of a higher ranking than the selected MCS when communication quality exceeds a first threshold;
changing the selected MCS to a MCS of a lower ranking than the selected MCS when the communication quality is less than a second threshold lower than the first threshold;
controlling the first threshold based on a first error rate; and
controlling the second threshold based on a second error rate different from the first error rate.
